(19) United States
(12) Patent Application Publication
(10) Pub. No.: US 2013/0288872 A1
(43) Pub. Date: Oct. 31, 2013

(54) FOLDING DEVICE OF A PRINTING PRESS AND PRINTING PRESS HAVING SUCH A FOLDING DEVICE AS WELL AS PRODUCTION METHODS FOR PRINT PRODUCTS

(71) Applicant: MANROLAND WEB SYSTEMS GMBH, Augsburg (DE)

(72) Inventors: Peter KNAUER, Muenster/Lech (DE); Hubert Schalk, Thierhaupten (DE); Stephen Uder, Aulzhausen (DE); Thomas Meyer, Augsburg (DE); Tilmar Geisler, Augsburg (DE)

(73) Assignee: manroland web systems GmbH, Augsburg (DE)

(21) Appl. No.: 13/871,817

(22) Filed: Apr. 26, 2013

(30) Foreign Application Priority Data
Apr. 27, 2012 (DE) 10 2012 103 729.9

(51) Int. Cl. B26D 7/27; B65H 45/16

(52) U.S. Cl. CPC B26D 7/27; B65H 45/16
USPC 493/324; 493/444

(57) ABSTRACT

A folding device of a printing press for folding signatures is disclosed. The folding device includes a folding blade cylinder, via which signatures to be folded can be fed to a jaw cylinder arranged downstream of the folding blade cylinder subject to forming transverse folds. A cylinder is arranged upstream of the folding blade cylinder, on which the signatures can be collected in any number prior to the forming of the transverse folds.

This application claims the priority of German Patent Document No. DE 10 2012 103 729.9, filed Apr. 27, 2012, the disclosure of which is expressly incorporated by reference herein.

### BACKGROUND AND SUMMARY OF THE INVENTION

The invention relates to a folding device of a printing press. The invention furthermore relates to a printing press having such a folding device and production methods for print products.

From practice, folding devices of printing presses are already known, with the help of which transverse folds and/or longitudinal folds can be formed on signatures cut off a printed web-like substrate. Here, pin folding devices and gripper folding devices are distinguished in principle, namely dependent on whether so-called folding blade cylinders of the folding devices utilize pins or grippers for position fixing of the signatures to be folded on the folding blade cylinder. From practice it is likewise already known to collect a plurality of signatures into a signature stack when folding the signatures. Here, with the folding devices known from practice, namely both with known pin folding devices as well as with known gripper folding devices it is not possible to change from a collect mode to a non-collect mode during the operation; the production rather has to be interrupted for this purpose. Furthermore, the number of collection operations with folding devices known from practice is restricted, i.e., either only two signatures or alternatively three signatures can be collected into a signature stack.

Starting out from this, the present invention is based on the object of creating a new type of folding device of a printing press as well as a digital printing press with such a folding device as well as methods for producing print products.

This object is solved through a folding device according to the present invention. According to the invention, a cylinder on which signatures can be collected prior to the forming of a transverse fold in the region of the jaw cylinder is arranged upstream of the folding blade cylinder.

The folding device according to the invention avoids the disadvantages of the folding devices known from practice. Thus, with the folding device according to the invention, it is possible to change backwards and forwards between a collect mode and a non-collect mode during the operation, i.e., with running production. Furthermore, the number of the signatures that can be collected into a signature stack is almost any and—likewise during the operation, the number of the signatures to be collected can be changed.

According to an advantageous further development of the invention, the cylinder is embodied as a pin collect cylinder, which interacts with a counter-cylinder or a tape line, which at the pin collect cylinder slides the signatures onto pins, wherein on the pin collect cylinder a number n (n=1 to N) signatures in the form of a signature stack of n signatures lying on top of one another can be collected, and wherein the signature stack can be transferred to the folding blade cylinder arranged downstream of the pin collect cylinder. By arranging the pin collect cylinder upstream of the folding blade cylinder of the folding device according to the invention it is possible with particularly simple design means to change backwards and forwards between a non-collect mode and a collect mode without stopping the production on the folding device with almost any number of collected signatures.

Alternatively, the collect cylinder can also be equipped with a gripper system instead of the pins.

The maximum number N of the signatures that can be collected on the collect cylinder on a signature stack is dependent on the width of a cylinder gap between the collect cylinder and the folding blade cylinder arranged downstream of the collect cylinder.

Preferred further developments of the invention are obtained from the following description. Exemplary embodiments of the invention are explained in more detail by the drawings without being restricted thereto.

### BRIEF DESCRIPTION OF THE DRAWINGS

FIG. 1 is a detail of a folding device of a printing press according to the invention;

FIG. 2 is a diagram of a printing press according to the invention with the folding device according to the invention;

FIG. 3 illustrates a broadsheet print product; and

FIG. 4 illustrates a tabloid print product.

### DETAILED DESCRIPTION OF THE DRAWINGS

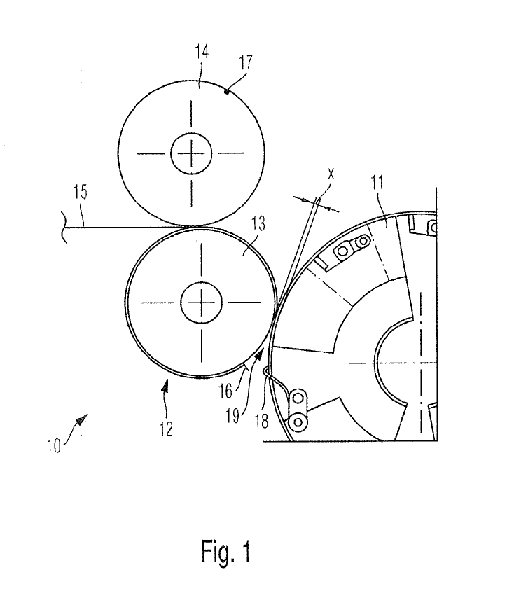

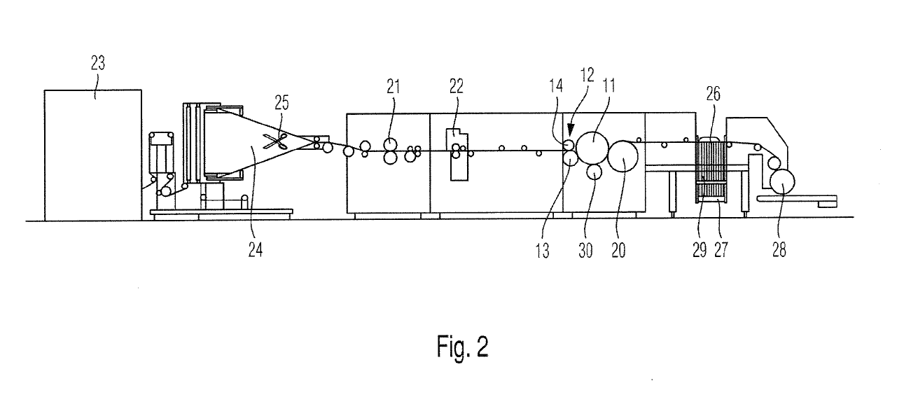

FIG. 1 shows a schematic detail of a folding device 10 of a printing press according to the invention, which serves at least for the transverse folding of signatures 15 or of signatures combined into a signature stack. In the shown preferred exemplary embodiment of the invention, the folding device 10 comprises a folding device cylinder 11 designed as a gripper cylinder, via which signatures 15 to be folded can be fed to a jaw cylinder which is not shown in FIG. 1 and is arranged downstream of the folding blade cylinder 11, in order to form at least one transverse fold on the signatures 15. The jaw cylinder 20 is shown in FIG. 2.

A cylinder 12 is arranged upstream of the folding blade cylinder 11 or in FIG. 1 the gripper cylinder 11, on which signatures 15 can be collected, wherein the cylinder 12 is a pin collect cylinder 13 and interacts with a counter-cylinder 14.

On the pin collect cylinder 13, a number n (n=1 to N) signatures can be collected in the form of a signature stack from n signatures 15 lying on top of one another. This signature stack can be transferred to the folding blade cylinder 11 arranged downstream of the pin collect cylinder 13.

The pin collect cylinder 13 comprises pins 16, which when rolling over the counter-cylinder 14 dip into depressions or into a plastic strip 17 of the counter-cylinder 14 and in the process pierce the signatures 15 to be collected in order to unite the signatures 15 to be collected on the pin collect cylinder 13 on top of one another into a signature stack. Instead of the depressions or the plastic strip 17 it is also possible to provide the entire cylinder surface of the counter-cylinder 14 with a surface in which the pins can enter (e.g., rubber, Vulkolan, or similar). Instead of a counter-cylinder it is also conceivable to provide other means which ensure that the pins 16 skewer the signatures 15 to be collected. To this end, tape lines can be provided, for example, which press the signatures against the surface of the pin collect cylinder 13. These would preferentially run as far as into the inlet gap, which the pin collect cylinder 13 forms with the folding blade cylinder 11. Alternatively, the tape line can be run as far as to the jaw cylinder 20. This means the tape line, which presses the signatures as upper tape against the collect cylinder, is then run about the folding blade cylinder as lower tape, i.e., located below the signatures. For sliding the signatures 15 onto the pins 16 which are preferentially aligned approximately in radial direction, other means can also be alternatively provided, such as, for example, pneumatically actuated brushes or slit strips or similar.

With each further revolution of the pin collect cylinder 13, the latter picks up a further signature 15 on its circumference, wherein a signature is to mean a copy that has been cut off an endless web, i.e., singled out. Such a copy or a signature can consist of one or of a plurality of layers.

When, as in the shown exemplary embodiment, a folding blade cylinder 11 designed as gripper cylinder 11 is arranged downstream of the cylinder pair 12, which can accept signatures or signature stacks with the help of a gripper 18 from the pin collect cylinder 13, the pins 16 of the pin collect cylinder 13 are designed fixed, which can then not be repositioned.

The signature stack can then be pulled off the pins 16 of the pin collect cylinder 13 via the gripper 18 of the folding blade cylinder 11 designed as gripper cylinder.

This takes place when on the circumference of the pin collect cylinder 13 the desired number of signatures 15 has been collected, in that the gripper 18 is suitably activated and pulls the signature stack off the pins 16 of the pin collect cylinder 13, and transporting them onwards on the circumference of the folding blade cylinder 11. On the pin collect cylinder 13, a new collection operation then commences, which only ends when the gripper 18 receives the control impulse for closing or gripping.

The maximum number N of the signatures that can be collected on the pin collect cylinder 13 into a signature stack is limited by the width x of a cylinder gap 19 formed between the pin collect cylinder 13 and the folding blade cylinder 11. The wider the cylinder gap 19, the more signatures can be collected into the signature stack. In order to be able to adjust the width x, the pin collect cylinder 13 can be enlarged or reduced in its distance to the folding blade cylinder 11. To this end, the collect cylinder 13, for example, could be arranged on a bearing which can be eccentrically moved.

Although the use of the gripper cylinder 11 shown in FIG. 1 as a folding blade cylinder is preferred, the folding blade cylinder 11 can also be provided by a pin cylinder, wherein in this case the pins 16 of the pin collect cylinder 13 are designed relocatable in such a manner that upon the transfer of a signature stack from the pin collect cylinder 13 to the folding blade cylinder 11 designed as pin cylinder the pins 16 of the pin collect cylinder 13 can be brought out of engagement with the signature stack. To this end, the pins 16 can, for example, be retracted in a controlled manner.

Instead of the gripper 18 of a folding blade cylinder 11 designed as gripper cylinder or of pins of a folding blade cylinder 11 designed as pin cylinder, the holding of the signatures or signature stacks in the region of the folding blade cylinder can also take place with other holding means, for example, electrostatically. The folding blade cylinder 11 is also described as folding blade and transfer cylinder.

As already explained, the signature stack can comprise a number n (n=1 to N) signatures, so that a signature stack accordingly can also mean a single signature. The signatures 15 can be cut off from a printed substrate, in particular a printed substrate web in a format-variable manner with the help of a cutting device which is not shown in FIG. 1, which is arranged upstream of the cylinder pair 12. The cutting device 21 is shown in FIG. 2.

The folding device 10 according to the invention allows changing between a non-collect mode and a collect mode of the folding device 10 in the production mode and accordingly without stopping the folding device 10, wherein in the collect mode the number n of the signatures to be collected into the signature stack can likewise be changed without stopping the folding device 10.

Between the cutting device 21, which serves for the cutting off of the signatures 15 from the substrate, and the pin collect cylinder 13, preferentially an acceleration section with an acceleration device 22 (see FIG. 2) for the cut-off signatures 15 is preferentially formed, in order to enlarge the distance between the individual signatures 15, so that these can be fed to the pin collect cylinder 13 in a defined manner.

When collecting signatures 15 into a signature stack on the pin collect cylinder 13, there is no danger that the individual signatures 15 slip relative to one another, since all signatures 15 during the collection operation remain skewered on the pin collect cylinder 13, namely on the pins 16 of the pin collect cylinder 13.

Accordingly, during the operation of the folding device 10, individual signatures 15 cut off a printed substrate, are fed to the cylinder pair 12 via an acceleration section. A leading edge of the individual signature 15 in this case is clamped between the cylinder pair 12, namely between the pin collect cylinder 13 and the counter-cylinder 14, wherein following this the pins 16 of the pin collect cylinder 13 pierce a newly fed-in signature 15, in this way skewering the latter on the pin collect cylinder 13. The number of the signatures 15 that can be collected into a signature stack is almost any and merely restricted by the width x of the cylinder gap 19 between the signature collect cylinder 13 and the folding blade cylinder 11. When a signature stack is to be transferred from the pin collect cylinder 13 onto the gripper cylinder 11, the acceptance takes place with the help of the gripper 18 of the gripper cylinder 11 and subsequently the formation of a transverse fold on the signature stack, namely in that folding knives which are not shown press the respective signature stack between jaws of the jaw cylinder 20 which are not shown.

When collection is to be continued, the gripper 18 of the gripper cylinder 11 does not accept the signature stack from the pin collect cylinder 13, but leaves the stack on the pin collect cylinder 13 for at least a further collection operation.

FIG. 2 shows the folding device 10 according to the invention as a part of a printing press. The printing press is preferably designed as digital printing press and comprises a digital printing unit 23 for the format-variable printing of a web-like substrate. The printing press could also operate according to the flexographic, rotogravure or other printing processes. Decisive hereby merely is that the printing press is capable of printing in a format-variable manner, i.e., print in particular different lengths in the unwinding direction. Furthermore, the printing press comprises the cutting device 21, in order to cut individual signatures 15 off the format-variably printed, web-like substrate in a format-variable manner, i.e., with different cut-off lengths. Furthermore, the printing press comprises the folding device 10 described above for the format-variable folding of the signatures 15 or signature stack and prior to this for the format-variable collecting of the signatures 15 in the region of the cylinder pair 12.

According to FIG. 2, a quarter folding device 24 can be arranged upstream of the cutting device 21, in order to form a longitudinal fold with or without a longitudinal cut 25 on the printed, web-like substrate prior to the cutting-off of the individual signatures 15. In addition to the shown one quarter folding device 24, a plurality of corresponding quarter folding devices could also be provided, as a result of which signatures with a corresponding number of layers are created.

For guiding the substrate web past the quarter folding device/s, suitable deflection rollers can be provided.

The acceleration device 22 arranged downstream of the cutting device 21 serves for the accelerating of the signatures 15 to the circumferential speed of the pin collect cylinder 13.

A quarter folding device 24 is preferably embodied as a horizontally arranged former.

In the shown preferred exemplary embodiment of the digital printing press, a collator 26 and a quarter folding device 29 are arranged downstream of the jaw cylinder 20, on which transverse folds can be formed on the signatures 15 collected into the signature stacks.

The collator 26 serves for collecting any number of transversely and, if applicable, longitudinally folded signatures 15 before or upstream of the quarter folding device 29. The at least transversely folded signatures are also called sections or books and, coming from the jaw cylinder 20, are placed on top of one another one after another in the collator 26 and thereby collected.

The quarter folding device 29 serves for the forming of a longitudinal fold on the sections or books collected in the collator. The longitudinal fold can be carried out both after collecting a single section or book or after collecting a plurality of sections/books, which after the joint quarter folding, for example, become a (broadsheet) newspaper. The number of jointly longitudinally folded sections or books is determined through corresponding activation of the quarter folding device 29, which carries out the folding operation only when the desired number of sections or books is collected in the collator.

In a first production mode of the printing press, the signatures which in the region of the jaw cylinder 20 have been transversely folded and, if applicable, longitudinally folded in the region of the quarter folding device 24 and/or longitudinally cut or the corresponding signatures stacks of such signatures 15 can be collected on the collator 26, wherein following this a first or, if applicable, second longitudinal fold can be formed on these in the region of the quarter folding device 29. Following this, the signatures 15 which have then been transversely folded and singly or doubly longitudinally folded or the signature stacks can be delivered via a longitudinal folding delivery 27—which can run into the figure plane or out of it.

In a second production mode, the signatures 15 which have been transversely folded in the region of the jaw cylinder and, if applicable, longitudinally folded in the region of the quarter folding device 24 and/or longitudinally cut or the corresponding signature stacks from such signatures 15 can be directly delivered subject to bypassing the quarter folding device 29 and of the collator 26 via a transverse folding delivery 28.

In the preferred exemplary embodiment, the folding blade cylinder 11 is assigned a cylinder stitching device 30, with the help of which the signatures 15 collected into a signature stack can be stitched, namely before the formation of the transverse folds in the region of the jaw cylinder 20. The collecting of signature stacks on the collator 26 takes place variably in any number of transversely folded and, if applicable, stitched signature stacks.

The printing press according to the invention can be used with particular advantage for producing so-called tabloid and broadsheet (news) print products.

In general, broadsheet is to mean the largest of the various newspaper formats, which is characterized by overlong page heights. According to the prior art, newspapers in broadsheet format are produced with reel-fed printing presses in that two, four or six pages of the newspaper are printed next to one another in the vertical format on a substrate web, which thereafter, if applicable, are longitudinally cut in the width of two pages standing next to one another and longitudinally folded via a former. During the quarter folding, the spine of a section or of a book of the broadsheet newspaper is created. The different sections or books of the broadsheet newspaper are guided on top of one another and together cut off the substrate web and additionally folded transversely on a folding cylinder, as a result of which the sections/books with the dispatch fold applied thereby are assembled into the finished newspaper product. In the case of broadsheet newspapers produced in this manner, through-stitches of pins of the folding cylinder are noticeable on the lower margin of the newspaper.

Print products in the tabloid format—in particular tabloid newspapers—are approximately half the size of broadsheet print products. On reel-fed printing presses according to the prior art, two tabloid pages are printed horizontally on the area of a broadsheet page and the substrate web is longitudinally cut open during the quarter folding in the page height of the tabloid product, as a result of which the part webs are placed on top of one another. Following this, the products are cut off the substrate web and transversely folded by a folding cylinder, as a result of which the spine of the tabloid newspaper is created. In the case of the tabloid format, the piercing holes of the pins are located on the side and the print product consists only of one section or one book.

With the printing press according to the invention it is particularly advantageously easily possible to produce the print products in small print runs—starting with one copy to any number.

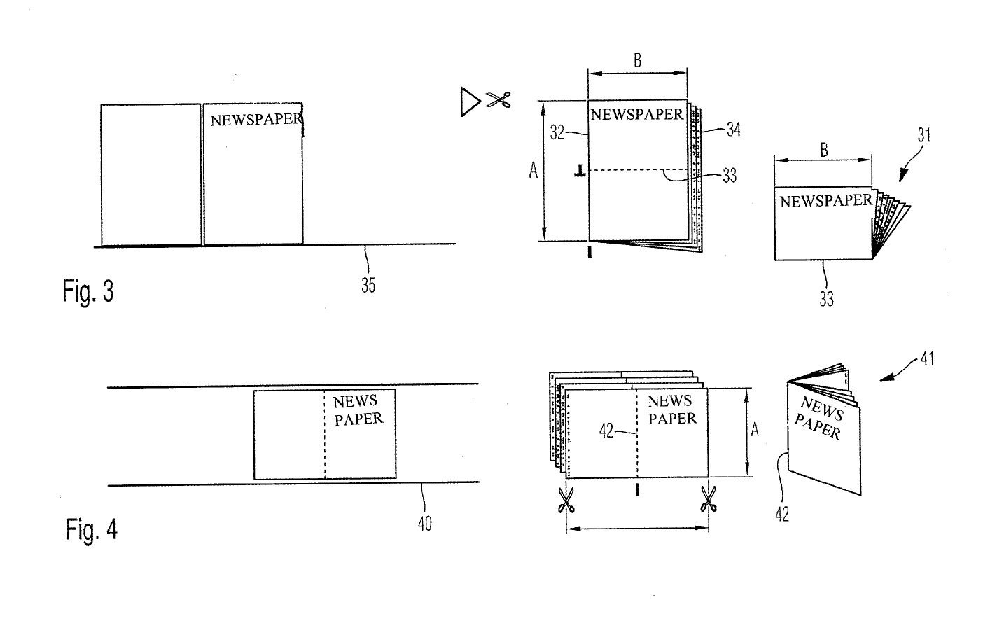

For producing a broadsheet print product according to the invention, in particular a broadsheet newspaper 31 (FIG. 3), all pages of the print product are printed one after the other horizontally on the front and back of the substrate web 35. It is also possible to use a substrate web in the width of two or more page heights A and to print two or more pages on top of one another on the substrate web 35. In this case, a quarter folding device is provided in each case, which longitudinally cuts open the substrate web in page height, placing the part webs on top of one another.

Following this, signatures with two pages (and back pages) each of the print product are cut off the substrate web 35 and fed to the collect cylinder 12 (FIG. 2), where all signatures of a section or book of the broadsheet print product 31 are collected.

After conclusion of the collection operation, a transverse fold is applied to the collected signature stack, as a result of which the spine 32 of a section or of a book of the broadsheet newspaper is created.

The sections or books formed through the transverse fold are likewise collected in the following, in that they are preferably placed on top of one another on the collator 26 (FIG. 2), i.e., stacked.

As soon as all sections or books of the broadsheet newspaper 31 have been collected, the so-called dispatch fold 33 is applied through quarter folding, as a result of which the sections/books are joined together into the broadsheet newspaper 31. The broadsheet newspapers 31 thus completed can then be delivered on the longitudinal folding delivery 27.

On a broadsheet newspaper 31 produced in this way, in which the spines are produced through a transverse fold, the pinholes 34, i.e., the piercings of the pins of the collect cylinder, are located on the lateral margin of the newspaper.

For producing a tabloid print product, in particular a tabloid newspaper 41 (FIG. 4), all pages of the print product are initially printed horizontally one after the other on the front and back of the substrate web 40.

After this, signatures, each having two pages of the print product, are cut off the substrate web 40 and fed to the collect cylinder 12 (FIG. 2), where all signatures of the tabloid print product are collected.

After conclusion of the collect operation, a transverse fold is applied to the collected signature stack, as a result of which the spine 42 of the tabloid newspaper is created.

The tabloid newspapers 41 thus completed can then be delivered on the transverse folding delivery 28.

If desired, the signature stack can be stitched together by the stitching device 30 on the folding blade cylinder 11.

### LIST OF REFERENCE NUMBERS

10 Folding device

11 Folding blade cylinder

12 Cylinder/collect cylinder

13 Pin collect cylinder

14 Counter-cylinder

15 Signature

16 Pin

17 Plastic strip

18 Gripper

19 Cylinder gap

20 Jaw cylinder

21 Cutting device

22 Acceleration device

23 Digital printing unit

24 Quarter folding device

25 Longitudinal cut

26 Collator

27 Quarter folding delivery

28 Transverse folding delivery

29 Quarter folding device

30 Cylinder stitching device

31 Broadsheet print products/broadsheet newspaper

32 Spine

33 Dispatch fold

34 Pinholes

35 Substrate web

40 Substrate web

41 Tabloid print product/tabloid newspaper

42 Spine

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A folding device of a printing press for folding signatures, comprising:
a folding blade cylinder;
a jaw cylinder disposed downstream of the folding blade cylinder; and
a cylinder disposed upstream of the folding blade cylinder, wherein a number n (n=1 to N) of signatures is collectable on the cylinder.

2. The folding device according to claim 1, wherein the cylinder is a pin collect cylinder and interacts with a counter-cylinder or a tape line, wherein the number of signatures is formed in a stack, and wherein the stack is transferrable to the folding blade cylinder.

3. The folding device according to claim 2, wherein a pin of the pin collect cylinder is dipable into a depression or into a plastic strip of the counter-cylinder.

4. The folding device according to claim 1, wherein the folding blade cylinder is a gripper cylinder and the cylinder is a pin collect cylinder and wherein a pin of the pin collect cylinder is fixed.

5. The folding device according to claim 1, wherein the folding blade cylinder is a pin cylinder and the cylinder is a pin collect cylinder and wherein a pin of the pin collect cylinder is relocatable.

6. The folding device according to claim 1, wherein N is dependent on a width of a cylinder gap between the cylinder and the folding blade cylinder.

7. A printing press for format-variable printing of a web-like substrate comprising a cutting device and a folding device according to claim 1, wherein the cutting device is disposed upstream of the cylinder.

8. The printing press according to claim 7, further comprising a quarter folding device disposed upstream of the cutting device.

9. The printing press according to claim 7, further comprising a collator and a quarter folding device disposed downstream of the jaw cylinder;
wherein in a first production mode, signatures are collectable on the collator, a longitudinal fold is formable on the signatures by the quarter folding device, and print products created in the first production mode are deliverable via a longitudinal folding delivery;
and wherein in a second production mode, signatures are deliverable via a transverse folding delivery by bypassing the collator and the quarter folding device.

10. The printing press according to claim 7, further comprising a cylinder stitching device associated with the folding blade cylinder.

11. A method for producing a broadsheet print product, comprising the steps of:
printing a substrate web:
cutting of signatures off the substrate web;
collecting a number of the signatures on a collect cylinder;
transverse folding of the collected signatures for creating a section or book;
quarter folding the section or book for producing the broadsheet print product; and
delivery of the broadsheet print product.

12. The method according to claim 11, further comprising the step of stitching the signatures together.

13. A method for producing a tabloid print product, comprising the steps of:
printing a substrate web;
cutting of signatures off the substrate web;
collecting a number of the signatures on a collect cylinder;
transverse folding of the collected signatures for creating a spine of the tabloid print product; and
delivery of the tabloid print product.

14. The method according to claim 13, further comprising the step of stitching the signatures together.
